(19) United States
(12) Patent Application Publication
(10) Pub. No.: US 2012/0089375 A1
(43) Pub. Date: Apr. 12, 2012

(54) SYSTEM AND METHOD FOR DETERMINING LOCAL ACCELERATIONS, DYNAMIC LOAD DISTRIBUTIONS AND AERODYNAMIC DATA IN AN AIRCRAFT

(76) Inventors: Michael Kordt, Hamburg (DE); Marianne Jacoba Reijerkerk, Oberschleissheim (DE)

(21) Appl. No.: 13/273,763

(22) Filed: Oct. 14, 2011

Related U.S. Application Data
(63) Continuation of application No. PCT/EP2010/052823, filed on Mar. 5, 2010.
(60) Provisional application No. 61/169,507, filed on Apr. 15, 2009.

(30) Foreign Application Priority Data
Apr. 15, 2009 (DE) 10 2009 002 392.5

(51) Int. Cl. G06F 17/50; G06G 7/70

(52) U.S. Cl. 703/1

(57) ABSTRACT

A method and a system for the integrated determination of aerodynamic data, dynamic load distributions and local accelerations in an aircraft, in particular in an airplane, in flight. Sensors for directly and indirectly detecting aerodynamic parameters, local acceleration and/or structural loads of the aircraft are provided at the aircraft. A calculation unit, which is provided within the aircraft or at the ground station, calculates based on a non-linear simulation model of the aircraft the aerodynamic data, local accelerations and dynamic load distributions of the aircraft depending on the detected aerodynamic parameters of the aircraft. The calculation may take place in real time.

### CROSS-REFERENCE TO RELATED APPLICATIONS

This application is a continuation of and claims priority to PCT/EP2010/052823 filed Mar. 5, 2010, which claims the benefit of and priority to U.S. Provisional Application No. 61/169,507, filed Apr. 15, 2009 and German Patent Application No. 10 2009 002 392.5, filed Apr. 15, 2009, the entire disclosures of which are herein incorporated by reference.

### FIELD OF THE INVENTION

The invention relates to a system and a method for integrated determination of local accelerations (as an indicator for comfort and passenger safety), dynamic load distributions and aerodynamic data in an aircraft, in particular in an aeroplane, during flight.

Aircraft, for example aeroplanes or helicopters, are subjected to different forces during their flight. Basic influences are the lift forces generated by the aerofoils, the aerodynamic resistance of the aircraft, the weight or gravitational force acting on the centre of gravity of the aircraft, the system forces, for example the thrust generated by the propulsion system or the control forces generated by the control surfaces of the aircraft and by the onboard and propulsion systems, and the torques produced by the respective forces. Local and global mass properties, structural dampings and rigidities of the aircraft components and of the entire aircraft play a role in the total force amount. During flight manoeuvres and turbulence, the total amount of forces indicated in this instance leads to structural loading and accelerations of the aircraft. These structural loads are key to the structural dimensioning of the aircraft. The accelerations are basically for passenger safety and comfort. All of the forces indicated can be ascertained by means of physical mathematical models and methods or simple ground-level and laboratory tests, with one exception. This exception is the aerodynamic forces and associated aerodynamic data including the local distributions thereof over the aircraft.

There is thus a need for a method and system which indentify the structural loads, accelerations and aerodynamic data in an integrated manner.

Compensation systems can be used to predict the flight behaviour of an aircraft but, owing to the large number of interrelations between aeroelastic and flight-mechanical movement variables, are relatively complex. Conventional simulation systems for simulating the behaviour of aircraft are largely based on linear models of structural dynamics, steady and unsteady aerodynamics, aeroelastics and flight mechanics.

Aerodynamic coefficients and other model parameters, such as measurement errors, gusts of wind, etc. are normally determined from flight test data. This flight test data is a stored time curve of control inputs and variables of the resultant flight dynamics of the aircraft. It is necessary to know such aerodynamic coefficients in order to generate simulation models which can be used, for example, to ascertain structural loads and local accelerations of an aircraft and therefore to dimension and optimise the comfort of the aircraft. Furthermore, these simulation models can be consulted for stability and comfort analyses, for examination of flight properties or for the design of autopilot systems.

In the previous approach, aerodynamic coefficients are ascertained globally for different aircraft types, that is to say local load distributions and local aerodynamic distributions remain unconsidered. Conventional methods, which are based on global aerodynamic coefficients, are therefore relatively inaccurate.

DE 10 2005 058 081 A1 describes a method for reconstructing gust and structural loads in aircraft. In this case an observer is generated on the basis of a non-linear model of the aircraft in order to describe the conditions of the aircraft in all six degrees of freedom and the resilient movements of the aircraft structure. The observer is constantly supplied with the data and measurements essential for describing the state of the aircraft. The gust speeds and structural loads, that is to say the manoeuvring and gust loads, are then calculated by the observer from the supplied data and measurements. However, the method described in DE 10 2005 058 081 A1 has the drawback that no aerodynamic data containing the force coefficients essential for load distribution is ascertained or transmitted, and therefore the physical accuracy of this conventional method is relatively low, in particular if it is used, similarly to the system developed in this instance, for systematic physical structural load identification at the start of a flight test of a new type of aircraft. The method of DE 10 2005 058 081 A1 is trialled and used if normal flight testing is complete and the aerodynamic data is sufficiently accurate. By contrast, the method according to the present invention can be used in particular at the start of testing and can ascertain in a highly accurate manner the aerodynamic data together with the structural loads and accelerations so that all physical force coefficients of the structural loads and accelerations are accurately known.

### SUMMARY OF THE INVENTION

An object of the present invention is therefore to provide a method and a system for determining aerodynamic data and dynamic load distributions in an aircraft, which method and system take into account the local distributions of force and moment and are highly accurate.

The method according to the present invention and the method described in DE 10 2005 058 081 A1 can be combined by identifying, in the best possible way, the aerodynamic data together with the structural loads using the method according to the present invention and, on the basis of this model, forming a physical observer for the system of DE 10 2005 058 081 A1 which can be used with minimal validation effort in mass-production aircraft for structural load monitoring.

The invention provides a system for integrated determination of aerodynamic data and dynamic load distributions in an aircraft during flight, said system comprising:

sensors for direct or indirect detection of aerodynamic parameters of the aircraft, and comprising a calculation unit which calculates, on the basis of a non-linear simulation model of the aircraft, the aerodynamic data and the dynamic load distributions of the aircraft as a function of the detected aerodynamic parameters of the aircraft.

By using a sensor system consisting of sensors, the system and method according to the invention make it possible to provide airline, flight test and simulator pilots as well as flight test, telemetry and development engineers with all aerodynamic data and time curves of all loads resulting from this aerodynamic data in a highly accurate manner. Said aerodynamic data and time curves can be provided in real-time in one possible embodiment.

The system and method according to the invention for integrated determination of aerodynamic data and dynamic load distributions in an aircraft enable both aircraft design optimisation and targeted pilot training in order to avoid peak loads during extreme flight situations or flight manoeuvres, to reduce fatigue loads on the aircraft and to avoid vibration-critical states. Furthermore, the aircraft can be optimised or the pilot can be trained in such a way that acceleration forces are reduced in the entire cabin area so as to increase passenger and crew safety and passenger comfort.

In addition to flight test pilots as well as flight test, telemetry and development engineers, the system and method according to the invention for integrated determination of aerodynamic data and dynamic load distributions in an aircraft also offer the advantage that the effort expended during flight testing of an aircraft to provide an admissible flight envelope can be minimised.

In the system according to the invention for determination of aerodynamic data, this data describes an interaction between the structure of the aircraft and the surrounding flow. This aerodynamic data includes local and global forces and moments.

Aerodynamic parameters of the aircraft are detected either directly or indirectly via sensors. These aerodynamic parameters detected by sensor are measured variables, such as forces, accelerations, pressures, moments or deformations and expansions of parts and components of the aircraft. The large number of different measured variables and aerodynamic parameters form a parameter vector. An aerodynamic parameter of the parameter vector can be detected via sensor either directly or indirectly. With indirect detection the respective aerodynamic parameter is calculated by means of a predetermined equation system from other measured variables detected via sensor.

### BRIEF DESCRIPTION OF THE DRAWINGS

Embodiments of the system according to the invention and of the method according to the invention for integrated determination of aerodynamic data and load distributions in an aircraft will be described below with reference to the accompanying figures, in which:

FIG. 1 shows a coordinate system of a non-linear simulation model of an aircraft used in the method according to the invention;

FIG. 2 is a block diagram of a possible embodiment of the system according to the invention for integrated determination of aerodynamic data;

FIG. 3 is a simple flow diagram of a possible embodiment of the method according to the invention for determining aerodynamic data and dynamic load distributions;

FIG. 4 is a diagram for explaining the method according to the invention;

FIGS. 5A and 5B are diagrams for explaining the non-linear simulation model of an aircraft on which the system according to the invention is based;

FIGS. 6A, 6B, 6C and 6D show specific cases of the non-linear simulation model on which the system according to the invention is based;

FIGS. 7 and 8 show an example of possible outputs of the system according to the invention.

### DESCRIPTION OF EXEMPLARY EMBODIMENTS

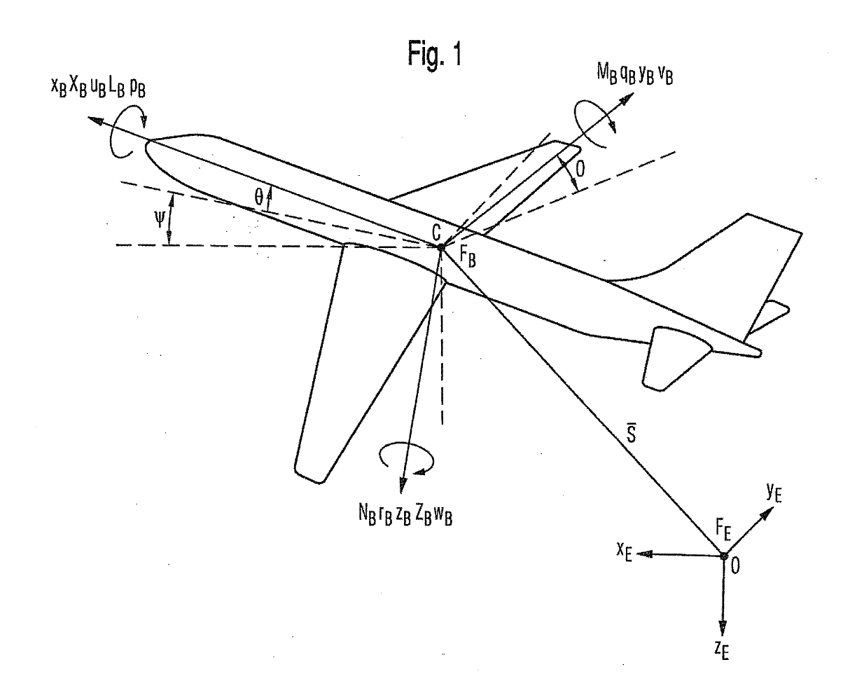

As can be seen from FIG. 1, the movements of an aircraft can be described on the basis of characteristic parameters. Flight mechanics describe the behaviour of an aircraft moving through the atmosphere with the aid of aerodynamics. Flight mechanics describe the behaviour of the entire system or of the aircraft, wherein a position, flying attitude and flying speed of a flying body are calculated at any moment in time. This occurs with the aid of motion equations, which form an equation system of coupled differential equations. Manoeuvring loads and structural loads act on an aircraft as a result of flight manoeuvres and turbulence. Manoeuvring loads can be described by means of non-linear motion equations and are based on databases which indicate the aerodynamic forces. In particular with large aircraft, the elastic deformations of the structure must also be taken into account in addition to non-linear movements.

The movement of a fixed aircraft can be described by system variables. In each case, three of these variables are combined to form a vector and describe the position:

\vec{S}=[xyz]^{T} (1)

angular position (Euler angle):

$$\vec{Φ} = [ \begin{matrix}φ \\ θ \\ ψ\end{matrix} ] \begin{matrix}hanging angle ( angle of roll ) \\ longitudinal inclination ( angle of pitch ) \\ control course ( yaw angle ) \end{matrix} \qquad ( 2 )$$

speed:

\vec{V}=[uυw]^{T} (3)

angular velocity:

$$\vec{Ω} = [ \begin{matrix}p \\ q \\ r\end{matrix} ] \begin{matrix}roll rate \\ pitch rate \\ yaw rate\end{matrix} \qquad ( 4 )$$

Causes of the movement are the forces acting on the aircraft,

weight:

\vec{G}=[GₓG_{y}G_{z}]^{T} (5)

thrust and aerodynamic forces as well as the moments thereof, the results of which are combined in the vectors
force:

\vec{R}=[XYZ]^{T} (6)

moment:

\vec{Q}=[LMN]^{T} (7)

A further important variable is the specific force measured by the acceleration metres.

\vec{b}=[bₓb_{y}b_{z}]^{T} (8)

The specific force is a measure for the acceleration input of the pilot in terms of magnitude and direction and is defined as the ratio of the resultant external force on the aircraft mass.

The accelerations and speeds with regard to an inertial system are measured in order to ascertain the Newtonian equations and the twist equation. The earth acts as an inertial system, wherein an earth-fixed coordinate system F_{E} is defined, in which the z axis points towards the centre of the earth, and the x and y axes are selected in such a way that a right-handed coordinate system is formed. For example, the axes of coordinates may be oriented towards the magnetic north. When evaluating the twist equation, it has proven to be advantageous to use a body-fixed coordinate system F_{B}, since the inertia sensor is then constant. There are different approaches for determining the axes of the body-fixed coordinate system, wherein each of which originates from the centre of gravity C of the aircraft. The main axis system is laid out in such a way that the x axis points towards the longitudinal axis of the aircraft and the z axis points downwardly perpendicular thereto. Cy is selected so that a right-handed coordinate system is formed. Once the stability axes have been selected, the x axis points towards flight speed. The other two axes are determined similarly to the main axes. FIG. 1 shows the primary dimensions as well as the relative position of flight- and earth-fixed coordinate systems.

In order to describe the aerodynamic forces more simply, an aerodynamic coordinate system F_{A} is selected which likewise originates from the centre of gravity C of the aircraft. The x axis of this coordinate system lies in the direction of negative approach velocity, whilst the z axis lies in the direction of negative lift. The y axis is selected similarly to the considerations above. This coordinate system is obtained by rotating the body-fixed main axis system about its y axis through an angle of incidence α and then about the z axis through an angle of sideslip β. The aerodynamic coordinate system F_{A} is only body-fixed in steady flight states of the aircraft.

The transition from body-fixed to earth-fixed coordinate systems occurs with the aid of a transformation matrix L_{EB}

$${\underline{L}}_{EB} = [ \begin{matrix}cos θcos ψ & \begin{matrix}sin φ sin θcos ψ - \\ cos φ sin ψ\end{matrix} & \begin{matrix}cos φ sin φ cos ψ + \\ sin φcos ψ\end{matrix} \\ cos θ sin ψ & \begin{matrix}sin φ sin θsin ψ + \\ cos φ cos ψ\end{matrix} & \begin{matrix}cos φ sin θ sin ψ - \\ sin φ cos ψ\end{matrix} \\ - sin θ & sin φ cos θ & cos φ cos θ\end{matrix} ] \qquad ( 9 )$$

The lower index provides the coordinate system in which the vectors are to be implemented. For example, the vector in the earth-fixed coordinate system F_{E} is obtained from the vector implemented in the body-fixed coordinates with \vec{R}_{E}:

\vec{R}_{E}=L_{EB}\vec{R}_{B} (10)

In order to simplify the notation, the index B will be left out hereinafter if it is not absolutely necessary. In the case of speed, a distinction must also be made between wind and calm air. The following is generally true with the speed addition law:

\vec{V}_{E}^{E}=\vec{V}_{E}^{B}+\vec{W}_{E} (11)

wherein the highest index determines the reference system in which the corresponding speeds are to be measured. \vec{W}_{E} is wind speed, which can be assumed to be zero. The values in both reference systems are therefore equal and the highest index can be left out.

With the components of the vectors \vec{V}, \vec{Ω} and \vec{Φ} as state variables, the motion equations in state space with calm air are obtained from the Newtonian equation and the twist equation, as well as the relationship between the Euler angles and their rates. In particular, the equations apply if the earth is considered to be an inertia system with a uniform gravitational field and the aeroplane or aircraft is symmetrical about its x-z plane. In accordance with the model the forces exerted act on the centre of gravity and the generation of aerodynamic forces is virtually steady.

The Newtonian equation for the centre of gravity of an aircraft with earth-fixed coordinates is as follows:

\vec{F}_{E}=m{right arrow over (\dot{V}_{E} (12)

This is transformed into the body-fixed coordinate system using the transformation matrix L_{EB}.

$$\begin{matrix}{\underline{L}}_{EB} \vec{F} = m \frac{d}{d t} ( {\underline{L}}_{EB} \vec{V} ) \\ = m ( {\underline{\dot{L}}}_{EB} \vec{V} + {\underline{L}}_{EB} {V}^{\dot{\to }} )\end{matrix} \qquad ( 13 )$$

The following is true:

L_{EB}\vec{V}=L_{EB}(\vec{Ω}×\vec{V} (14)

from which:

L_{EB}\vec{F}=L_{EB}m(\vec{Ω}×\vec{V}+{right arrow over (\dot{V}) (15)

The resultant force \vec{F} is formed from the aerodynamic force \vec{R} and the weight \vec{G}=L_{EB}⁻\vec{G}_{E}. These relationships are used in the above equation and are then solved for {dot over (\vec{V}.

$${V}^{\dot{\to }} = \frac{1}{m} ( \vec{R} + {\underline{L}}_{EB}^{- 1} {\vec{G}}_{E} ) - \vec{Ω} \times \vec{V} \qquad ( 16 )$$

The equations for the speeds are then determined. The relationships for the rates are obtained similarly from the twist equation with twist \vec{H} and inertia sensor I:

$${\vec{Q}}_{E} = {{H}^{\dot{\to }}}_{E} \\ \begin{matrix}{\underline{L}}_{EB} \vec{Q} = \frac{d}{d t} ( {\underline{L}}_{EB} {\vec{H}}_{E} ) \\ = {\underline{\dot{L}}}_{EB} \vec{H} + {\underline{L}}_{EB} {H}^{\dot{\to }} \\ = {\underline{L}}_{EB} ( \vec{Ω} \times \underline{I} \vec{Ω} + \underline{I} {Ω}^{\dot{\to }} )\end{matrix} \\ {Ω}^{\dot{\to }} = {\underline{I}}^{- 1} \vec{Ω} - {\underline{I}}^{- 1} \vec{Ω} \times \underline{I} \vec{Ω} \qquad ( 17 )$$

Together with the equations between Euler angles and their rates, these relationships split into components give the state equations of a fixed aircraft.

$$\dot{u} = \frac{1}{m} X - g sin θ - qw + rv \\ \dot{v} = \frac{1}{m} Y + g cos θ sin φ - ru + pw \\ \dot{w} = \frac{1}{m} Z + g cos θcos φ - pv + qu \\ \dot{p} = \frac{1}{{I}_{z} {I}_{x} - {I}_{zx}^{2}} [ qr ( {I}_{y} {I}_{z} - {I}_{z}^{2} - {I}_{zx}^{2} ) + {qpI}_{zx} ( {I}_{z} + {I}_{x} - {I}_{y} ) + {LI}_{z} + {NI}_{zx} ) \\ \dot{q} = \frac{1}{{I}_{y}} [ rp ( {I}_{z} - {I}_{x} ) + {I}_{zx} ( {r}^{2} - {p}^{2} ) + M ] \\ \dot{r} = \frac{1}{{I}_{z} {I}_{x} - {I}_{zx}^{2}} [ {qrI}_{zx} ( {I}_{y} - {I}_{z} - {I}_{x} ) + qp ( {I}_{zx}^{2} + {I}_{x}^{2} - {I}_{x} {I}_{y} ) + {LI}_{zx} + {NI}_{x} ] \\ \dot{φ} = p + ( q sin φ + r cos φ ) tan θ \\ \dot{θ} = q cos φ - r sin φ \\ \dot{ψ} = \frac{1}{cos θ} ( q sin φ + r cos φ ) \qquad ( 18 )$$

By transforming the speed \vec{V} into the earth-fixed coordinate system where

\vec{V}_{E}=L_{EB}\vec{V} (19)

the differential equations for calculating position are obtained:

\dot{x}_{E}=u cos θ cos ψ+υ(sin φ sin θ cos ψ−cos φ sin ψ)+w(cos φ sin θ cos ψ+sin φ sin ψ)

\dot{y}_{E}=u cos θ sin ψ+υ(sin φ sin θ sin ψ+cos φ cos ψ)+w(cos φ sin θ sin ψ−sin φ cos ψ)

ż_{E}=−u sin θ+υ sin φ cos θ+w cos φ cos θ (20)

For the specific force the following is obtained in body-fixed coordinates for a sensor located on the x axis at a distance xₚ from the centre of gravity:

$$[ \begin{matrix}{b}_{x} \\ {b}_{y} \\ {b}_{z}\end{matrix} ] = [ \begin{matrix}\dot{u} \\ \dot{v} \\ w\end{matrix} ] - g [ \begin{matrix}- sin θ \\ sin φcos θ \\ cos φcos θ\end{matrix} ] + {x}_{p} [ \begin{matrix}- ( {q}^{2} + {r}^{2} ) \\ \dot{r} \\ - \dot{q}\end{matrix} ] \qquad ( 21 )$$

If the vector entries are divided by the earth acceleration

$$g = 9.81 \frac{m}{s}$$

the specific load factor
nₓ=bₓ/g, n_{y}=b_{y}/g, n_{z}=b_{z}/g is given.

The above motion equations apply to an ideally fixed aircraft In practice however, elastic deformations of the structure occur and notably influence the dynamic properties of the system. The model is therefore expanded by these elastic degrees of freedom. Virtually static deformations occur if the inherent frequencies of the elastic modes are much higher than those of the fixed body modes. In this case the influence of the elastic deformation can be taken into account by correspondingly adapting the aerodynamic derivatives. If the inherent frequencies of the elastic degrees of freedom lie in the same range, the movement of the fixed body is influenced by the elastic deformations. In this case the dynamics of the elastic degrees of freedom are to be taken into account in the motion equations. For this purpose, a transition is made to a discrete modelling of the continuous flight structure, with a high but finite number of points which can be numbered consecutively using the index i. The deformations of the structure at each point i (within the meaning of finite element modelling) of the aircraft and the accelerations associated herewith can be described approximately by superposition of normal modes of free oscillation:

$${x}_{i}^{′} ( t ) = {\sum }_{n = 1}^{∞} {f}_{i , n} ( {x}_{i , 0} , {y}_{i , 0} , {z}_{i , 0} ) {ɛ}_{n} ( t ) \\ {y}_{i}^{′} ( t ) = {\sum }_{n = 1}^{∞} {g}_{i , n} ( {x}_{i , 0} , {y}_{i , 0} , {z}_{i , 0} ) {ɛ}_{n} ( t ) \\ {z}_{i}^{′} ( t ) = {\sum }_{n = 1}^{∞} {h}_{i , n} ( {x}_{i , 0} , {y}_{i , 0} , {z}_{i , 0} ) {ɛ}_{n} ( t ) \\ {\ddot{x}}_{i}^{′} ( t ) = {\sum }_{n = 1}^{∞} {f}_{i , n} ( {x}_{i , 0} , {y}_{i , 0} , {z}_{i , 0} ) {\ddot{ɛ}}_{n} ( t ) \\ {\ddot{y}}_{i}^{′} ( t ) = {\sum }_{n = 1}^{∞} {g}_{i , n} ( {x}_{i , 0} , {y}_{i , 0} , {z}_{i , 0} ) {\ddot{ɛ}}_{n} ( t ) \\ {\ddot{z}}_{i}^{′} ( t ) = {\sum }_{n = 1}^{∞} {h}_{i , n} ( {x}_{i , 0} , {y}_{i , 0} , {z}_{i , 0} ) {\ddot{ɛ}}_{n} ( t ) \qquad ( 22 )$$

xᵢ′, yᵢ′, zᵢ′ are the deviations from the respective rest positions x_{i,0}, y_{i,0}, z₀
\ddot{x}′ᵢ, ÿᵢ′, \ddot{z}ᵢ′ are the associated accelerations;
ƒ_{i,n}, g_{i,n} and h_{i,n} are the mode form functions and εₙ the generalised coordinates or generalised mode deviations and accordingly \ddot{ε}ₙ the associated generalised mode accelerations.

If xᵢ′, yᵢ′, zᵢ′ or \ddot{x}′ᵢ, ÿᵢ′, \ddot{z}ᵢ′ are used for all indices i, which belong to an aircraft portion or component, the deviation and acceleration distributions are thus obtained for an aircraft portion or component.

The additional motion equations for each mode εₙ are obtained from the Lagrange's equation as equations of enforced oscillations. The following applies approximately for the mode εₙ with the inherent frequency ωₙ of damping dₙ and the generalised moment of inertia Iₙ

$${\ddot{ɛ}}_{n} + 2 {d}_{n} {ω}_{n} \dot{ɛ} + {ω}_{n}^{2} {ɛ}_{n} = \frac{{F}_{n}}{{I}_{n}} \qquad ( 23 )$$

The approximation lies in disregarding all couplings between the individual modes over the damping term. On the assumption that the influence of the degrees of freedom of the fixed body on the elastic modes can be described by a linear correlation and the elastic deformations are sufficiently small, the generalised force Fₙ is illustrated as a linear combination of state and input variables:

$${F}_{n} = {a}_{nu} Δ u + {a}_{n \dot{u}} \dot{u} + … + {a}_{np} p + … + {a}_{n {δ}_{r}} {δ}_{r} + … + {\sum }_{j = 1}^{∞} {a}_{nj} {ɛ}_{j} + {\sum }_{j = 1}^{∞} {b}_{nj} {\dot{ɛ}}_{j} + {\sum }_{j = 1}^{∞} {c}_{nj} {\ddot{ɛ}}_{j} \qquad ( 24 )$$

The infinite series occurring here can be replaced by finite series which only contain those modes which lie in the range of the fixed body frequencies. For further calculation it can be assumed that these are k modes which are combined in a vector ε. The equation (24) can thus be written in the following form:

$$\begin{matrix}{F}_{n} = {a}_{nu} Δ u + {a}_{n \dot{u}} \dot{u} + … + {a}_{np} p + … + {a}_{n {δ}_{r}} {δ}_{r} + … + \\ {\sum }_{j = 1}^{k} {a}_{nj} {ɛ}_{j} + {\sum }_{j = 1}^{k} {b}_{nj} {\dot{ɛ}}_{j} + {\sum }_{j = 1}^{k} {c}_{nj} {\ddot{ɛ}}_{j} \\ = {a}_{nu} Δ u + {a}_{n \dot{u}} \dot{u} + … + {a}_{np} p + … + {a}_{n {δ}_{r}} {δ}_{r} + … + \\ {\underline{a}}_{n ɛ}^{T} \underline{ɛ} + {\underline{b}}_{n \dot{ɛ}}^{T} \dot{\underline{ɛ}} + {\underline{c}}_{n \ddot{ɛ}}^{T} \ddot{\underline{ɛ}}\end{matrix} \qquad ( 25 )$$

In order to obtain a compact notation for all modes, the generalised moments of inertia Iₙ are combined in the diagonal matrix I, the scalar couplings are each combined in vectors and the vector coupling terms are combined in matrices. Equation (24) can thus be formulated for all modes.

\ddot{ε}+2dω^{T}\dot{ε}+ωω^{T}ε=I⁻¹(aᵤΔu+a_{\dot{u}}\dot{u}+ . . . +aₚp+ . . . +a_{δ}_{ᵣ}δᵣ+ . . . +A_{ε}ε+B_{\dot{ε}}+C_{\ddot{ε}}\ddot{ε}) (26)

The mode speed \dot{ε}=ν is introduced for illustration in state space. This is used in equation (26):

\dot{ν}+2dω^{T}ν+ωω^{T}ε=I⁻¹(aᵤΔu+a_{\dot{u}}\dot{u}+ . . . +aₚp+ . . . +a_{δ}_{ᵣ}δᵣ+ . . . +A_{ε}ε+B_{ν}ν+C_{\dot{ν}}\dot{ν}) (27)

With use of the matrices

A_{\dot{x}}_{₁}=[a_{\dot{u}}a_{\dot{υ}}a_{\dot{w}}a_{\dot{p}}a_{\dot{q}}a_{\dot{r}}],

Aₓ_{₁}=[aᵤa_{υ}a_{w}aₚa_{q}aᵣ],

A_{c}=[a_{δ}_{_{E}}a_{δ}_{_{A}}a_{δ}_{_{R}}a_{δ}_{_{C}}a_{δ}_{_{F}}], (28)

and the unit matrix of k^{th} order Iₖ, the following state equation can be formulated:

\dot{ε}=ν

\dot{ν}=(Iₖ−I⁻¹C_{\dot{ν}})⁻¹[(I⁻¹B_{ν}−2dω

T)ν+(I⁻¹A_{ε}−ωω^{T})ε+A\hat{x}_{₁}\dot{x}₁+Aₓ_{₁}x₁A_{c}c] (29)

In addition to weight, the external forces acting on an aircraft are the aerodynamic forces of lift and resistance as well as thrust. The point of application of the lift lies at the “neutral point”, which is different from the centre of gravity. Moments are thus generated. The same applies to the thrust. The resultant forces are combined in a vector \vec{R}, and the moments are combined in a vector \vec{Q}. Lift and resistance are generated by the relative movement of the aircraft and air, that is to say by \vec{V} and \vec{Ω}. These forces further depend on the angle of incidence α and the angles of the control surfaces of the primary flight controls, elevator (δ_{E}), aileron (δ_{A}) and rudder (δ_{R}). Depending on the type of aircraft, further control surfaces, disrupter flaps, spoilers and canards are used and are referred to hereinafter by δ_{C}. The angles of the control surfaces are combined, together with the thrust δF_{,} into a control vector c. The aerodynamic effects are based on non-linear correlations. They can be described by Taylor's series, which are terminated after a specific order. The coefficients of the members of second and third order lie below the coefficients of first order by one to two orders of magnitude. If the angle of incidence remains below 10°, the terms of higher order can be ignored. The starting point of the linear approach is a steady flight state. The speeds and rates as well as forces and moments are divided into a steady term and an error term:

u=u₀+Δu X=X₀+ΔX p=p₀+Δp L=L₀+ΔL

υ=υ₀+ΔυY=Y₀+ΔY q=q₀+Δq M=M₀+ΔM

w=w₀+Δw Z=Z₀+ΔZ r=r₀+Δr N=N₀+ΔN (30)

The horizontal symmetrical straight flight can be selected as the steady flight state. If the stability axes are additionally selected as flight-fixed coordinate systems, the above relationships are simplified, since in this state X₀=Y₀=L₀=M₀=N₀=0 and w₀=u₀=p₀=q₀=r₀=0. Since with horizontal flight the z axes of flight- and earth-fixed coordinate systems are parallel, Z₀=−mg. Furthermore, the following applies approximately w≈u₀α.

$$[ \begin{matrix}X \\ Z \\ M \\ Y \\ L \\ N\end{matrix} ] = [ \begin{matrix}0 \\ - m g \\ 0 \\ 0 \\ 0 \\ 0\end{matrix} ] + [ \begin{matrix}{X}_{u} & {X}_{w} & {X}_{\dot{w}} & {X}_{q} & 0 & 0 & 0 & 0 & {\underline{X}}_{ɛ} & {\underline{X}}_{v} & {\underline{X}}_{c} \\ {Z}_{u} & {Z}_{w} & {Z}_{\dot{w }} & {Z}_{q} & 0 & 0 & 0 & 0 & {\underline{Z}}_{ɛ} & {\underline{Z}}_{v } & {\underline{Z}}_{c} \\ {M}_{u} & {M}_{w} & {M}_{\dot{w}} & {M}_{q} & 0 & 0 & 0 & 0 & {\underline{M}}_{ɛ} & {\underline{M}}_{v} & {\underline{M}}_{c} \\ 0 & 0 & 0 & 0 & {Y}_{v} & {Y}_{\dot{v}} & {Y}_{p} & {Y}_{r} & {\underline{Y}}_{ɛ} & {\underline{Y}}_{v} & {\underline{Y}}_{c} \\ 0 & 0 & 0 & 0 & {L}_{v} & {L}_{\dot{v}} & {L}_{p} & {L}_{r} & {\underline{L}}_{ɛ} & {L}_{v} & {L}_{c} \\ 0 & 0 & 0 & 0 & {N}_{v} & {N}_{\dot{v}} & {N}_{p} & {N}_{r} & {\underline{N}}_{ɛ} & {\underline{N}}_{v} & {\underline{N}}_{c}\end{matrix} ] [ \begin{matrix}Δ u \\ w \\ \dot{w} \\ q \\ v \\ \dot{v} \\ p \\ r \\ \underline{ɛ} \\ \underline{v} \\ \underline{c}\end{matrix} ] \qquad ( 31 )$$

The variables indicated in equation (31) by v and ε describe the influence of the elastic modes on aerodynamics. They are each vectors of length k, wherein k is the number of elastic modes. The derivatives indicated by c are also vectors and describe the influence of the control variables. Their dimension is the same as the number of control variables.

The above derived equations are combined to form a model with which the entire dynamics of the flexible aircraft can be described with the assumptions indicated in the paragraphs above. The states for describing the movement of the fixed body are combined in the vector

xᵢ=[Δuwqθυprφψ]^{T} (32)

ε and v denote the elastic modes introduced, whilst the control variables are contained in the vector c. Similarly to the introduction of aerodynamic forces, symmetrical, horizontal straight flight is also assumed in this instance. All error terms are assumed to be sufficiently small so that the linear approximation is valid for the aerodynamics. A_{\dot{x}}_{₁} is also ignored. On the basis of these assumptions, the motion equations can be written in the following form:

$$\begin{matrix}[ \begin{matrix}{\underline{\dot{x}}}_{1} \\ \underline{\dot{ɛ}} \\ \underline{\dot{v}}\end{matrix} ] = [ \begin{matrix}{\underline{A}}_{11} & {\underline{A}}_{12} & {\underline{A}}_{13} \\ \underline{0} & \underline{0} & {\underline{I}}_{k} \\ {\underline{A}}_{31} & {\underline{A}}_{32} & {\underline{A}}_{33}\end{matrix} ] [ \begin{matrix}{\underline{x}}_{1} \\ \underline{ɛ} \\ \underline{v}\end{matrix} ] + [ \begin{matrix}{\underline{B}}_{1} \\ \underline{0} \\ {\underline{B}}_{3}\end{matrix} ] \underline{c} + [ \begin{matrix}\underline{F} \\ \underline{0} \\ \underline{0}\end{matrix} ] \underline{g} ( {\underline{x}}_{1} ) & ( 33 ) \\ \underline{b} = [ {\underline{C}}_{1} {\underline{C}}_{2} {\underline{C}}_{3} ] [ \begin{matrix}{\underline{x}}_{1} \\ \underline{ɛ} \\ \underline{v}\end{matrix} ] + \underline{H} \underline{h} ( {\underline{x}}_{1} ) + \underline{D} \underline{c} & ( 34 )\end{matrix}$$

The sub-matrices used in equations (33) and (34) are compiled with the following abbreviations:

Δ=I_{z}Iₓ−I_{zx}²

I_{qr1}=I_{y}I_{z}−I_{z}²−I_{zx}² I_{pq1}=I_{zx}(I_{z}+Iₓ−I_{y})

I_{qr2}=I_{zx}(I_{y}−I_{z}−Iₓ) I_{pq2}=I_{zx}²+Iₓ²−IₓI_{y}

m_{\dot{w}}−Z_{\dot{w}} m_{\dot{υ}}m−Y_{\dot{υ}}

L′ᵢ=I_{z}Lᵢ+I_{zx}Nᵢ N′ᵢ=I_{zx}Lᵢ+IₓNᵢ (35)

$$\begin{matrix} {\underline{A}}_{11} = [ \begin{matrix}{\underline{A}}_{long} & \underline{0} \\ \underline{0} & {\underline{A}}_{lat}\end{matrix} ] & ( 36 ) \\ {\underline{A}}_{long} = [ \begin{matrix}\frac{{X}_{u}}{m} + \frac{{Z}_{u} {X}_{\dot{w}}}{{m}_{\dot{w}} m} & \frac{{X}_{w}}{m} + \frac{{Z}_{w} {X}_{\dot{w}}}{{m}_{\dot{w}} m} & \frac{{X}_{q}}{m} + \frac{{X}_{w} ( {Z}_{q} + {mu}_{0} )}{{m}_{\dot{w}} m} & 0 \\ \frac{{Z}_{u}}{{m}_{\dot{w}}} & \frac{{Z}_{w}}{{m}_{\dot{w}}} & \frac{{Z}_{q} + {mu}_{0}}{{m}_{\dot{w}}} & 0 \\ \frac{1}{{I}_{y}} ( {M}_{u} + \frac{{M}_{\dot{w}} {Z}_{u}}{{m}_{\dot{w}}} ) & \frac{1}{{I}_{y}} ( {M}_{w} + \frac{{M}_{\dot{w}} {Z}_{w}}{{m}_{\dot{w}}} ) & \frac{1}{{I}_{y}} ( {M}_{q} + \frac{{M}_{\dot{w}} ( {Z}_{q} + {mu}_{0} )}{{m}_{\dot{w}}} ) & 0 \\ 0 & 0 & 0 & 0\end{matrix} ] & ( 37 ) \\ {\underline{A}}_{lat} = [ \begin{matrix}\frac{{Y}_{v}}{{m}_{\dot{v}}} & \frac{{Y}_{p}}{{m}_{\dot{v}}} & \frac{{Y}_{r} - {mu}_{0}}{{m}_{\dot{v}}} & 0 & 0 \\ \frac{{L}_{v}^{′}}{Δ} + {Y}_{v} \frac{{L}_{\dot{v}}^{′}}{Δ {m}_{\dot{v}}} & \frac{{L}_{p}^{′}}{Δ} + {Y}_{p} \frac{{L}_{\dot{v}}^{′}}{Δ {m}_{\dot{v}}} & \frac{{L}_{r}^{′}}{Δ} + \frac{{L}_{\dot{v}}^{′} ( {Y}_{r} - {mu}_{0} )}{Δ {m}_{\dot{v}}} & 0 & 0 \\ \frac{{N}_{v}^{′}}{Δ} + {Y}_{v} \frac{{N}_{\dot{v}}^{′}}{Δ {m}_{\dot{v}}} & \frac{{N}_{p}^{′}}{Δ} + {Y}_{p} \frac{{N}_{\dot{v}}^{′}}{Δ {m}_{\dot{v}}} & \frac{{N}_{r}^{′}}{Δ} + \frac{{N}_{\dot{v}}^{′} ( {Y}_{r} - {mu}_{0} )}{Δ {m}_{\dot{v}}} & 0 & 0 \\ 0 & 1 & 0 & 0 & 0 \\ 0 & 0 & 0 & 0 & 0\end{matrix} ] & ( 38 ) \\ {\underline{A}}_{12} = {[ {\underline{A}}_{12 long} {\underline{A}}_{12 lat} ]}^{T} & ( 39 )\end{matrix}$$

wherein

$${A}_{12 lon g} = [ \frac{{\underline{X}}_{ɛ}^{T}}{m} + \frac{{\underline{Z}}_{ɛ} {X}_{\dot{w}}}{{m}_{\dot{w}} m} \frac{{\underline{Z}}_{ɛ}^{T}}{{m}_{\dot{w}}} \frac{1}{{I}_{y}} {( {\underline{M}}_{ɛ} + \frac{{M}_{\dot{w}} {\underline{Z}}_{ɛ}}{{m}_{\dot{w}}} )}^{T} {\underline{0}}^{T} ] \\ {A}_{12 lat} = [ \frac{{\underline{Y}}_{ɛ}^{T}}{{m}_{\dot{v}}} \frac{1}{Δ} {( {\underline{L}}_{ɛ}^{′} + \underline{{Y}_{ɛ}} \frac{{L}_{\dot{v}}^{′}}{Δ {m}_{\dot{v}}} )}^{T} \frac{1}{Δ} {( {\underline{N}}_{ɛ}^{′} + {\underline{Y}}_{ɛ} \frac{{N}_{\dot{v}}^{′}}{Δ {m}_{\dot{v}}} )}^{T} {\underline{0}}^{T} {\underline{0}}^{T} ] \qquad ( 40 )$$

The matrices A₁₃ and B₁ are obtained by replacing the index ε in the matrix A₁₂ with v or c respectively. The following applies to the other matrices:

$$\begin{matrix} {\underline{A}}_{31} = {( {\underline{I}}_{k} - {\underline{I}}^{- 1} {\underline{C}}_{\dot{v}} )}^{- 1} {\underline{A}}_{{x}_{1}} , \\ {\underline{A}}_{32} = {( {\underline{I}}_{k} - {\underline{I}}^{- 1} {\underline{C}}_{\dot{v}} )}^{- 1} ( {\underline{I}}^{- 1} {\underline{A}}_{ɛ} - \underline{ω} \underline{{ω}^{T}} ) , \\ {\underline{A}}_{33} = {( {\underline{I}}_{k} - {\underline{I}}^{- 1} {\underline{C}}_{\dot{v}} )}^{- 1} ( {\underline{I}}^{- 1} {\underline{B}}_{v} - 2 \underline{d} \underline{{ω}^{T}} ) , \\ {\underline{B}}_{3} = {( {\underline{I}}_{k} - {\underline{I}}^{- 1} {\underline{C}}_{\dot{v}} )}^{- 1} {\underline{A}}_{c} , & ( 41 ) \\ \underline{F} = [ \begin{matrix}- g & \frac{{gX}_{\dot{w}}}{{m}_{\dot{w}}} & 0 & 0 & 0 & 0 & 1 & \frac{{X}_{\dot{w}}}{{m}_{\dot{w}}} & 0 & 0 & 0 & 0 & 0 \\ 0 & \frac{mg}{{m}_{\dot{w}}} & 0 & 0 & 0 & 0 & 0 & \frac{m}{{m}_{\dot{w}}} & 0 & 0 & 0 & 0 & 0 \\ 0 & \frac{{M}_{\dot{w}} mg}{{I}_{y} {m}_{\dot{w}}} & 0 & 0 & 0 & 0 & 0 & \frac{{M}_{\dot{w}} m}{{I}_{y} {m}_{\dot{w}}} & 0 & 0 & 0 & \frac{{I}_{z} - {I}_{x}}{{I}_{y}} & \frac{{I}_{zx}}{{I}_{y}} \\ 0 & 0 & 1 & 0 & 0 & 0 & 0 & 0 & 0 & 0 & 0 & 0 & 0 \\ 0 & 0 & 0 & \frac{mg}{{m}_{\dot{v}}} & 0 & 0 & 0 & 0 & \frac{m}{{m}_{\dot{v}}} & 0 & 0 & 0 & 0 \\ 0 & 0 & 0 & \frac{{mgL}_{\dot{v}}^{′}}{Δ {m}_{\dot{v}}} & 0 & 0 & 0 & 0 & \frac{{mL}_{\dot{v}}^{′}}{Δ {m}_{\dot{v}}} & \frac{{I}_{qr 1}}{Δ} & \frac{{I}_{pq 1}}{Δ} & 0 & 0 \\ 0 & 0 & 0 & \frac{{mgN}_{\dot{v}}^{′}}{Δ {m}_{\dot{v}}} & 0 & 0 & 0 & 0 & \frac{{mN}_{\dot{v}}^{′}}{Δ {m}_{\dot{v}}} & \frac{{I}_{qr 2}}{Δ} & \frac{{I}_{pq 2}}{Δ} & 0 & 0 \\ 0 & 0 & 0 & 0 & 1 & 0 & 0 & 0 & 0 & 0 & 0 & 0 & 0 \\ 0 & 0 & 0 & 0 & 0 & 1 & 0 & 0 & 0 & 0 & 0 & 0 & 0\end{matrix} ] & ( 42 ) \\ \underline{g} ( {\underline{x}}_{1} ) = [ \begin{matrix}sin θ \\ cos θcos φ - 1 \\ q cos φ - r sin φ \\ cos θsin φ \\ ( q sin φ + r cos φ ) tan θ \\ \frac{1}{cos θ} ( q sin φ + r cos φ ) \\ - qw + rv \\ - pv + q Δ u \\ - r Δ u + pw \\ qr \\ pq \\ rp \\ {r}^{2} - {p}^{2}\end{matrix} ] & ( 43 ) \\ {\underline{C}}_{1} = [ {\underline{C}}_{1 long} {\underline{C}}_{1 lat} ] , & ( 44 ) \\ {\underline{C}}_{1 long} = [ \begin{matrix}\frac{{X}_{u}}{m} + \frac{{Z}_{\dot{w}} {Z}_{u}}{m {m}_{\dot{w}}} + {{\underline{K}}_{x} ( {\underline{I}}_{k} - {\underline{I}}^{- 1} {\underline{C}}_{\dot{v}} )}^{- 1} {\underline{a}}_{u} & \frac{{X}_{w}}{m} + \frac{{Z}_{\dot{w}} {Z}_{w}}{m {m}_{\dot{w}}} + {{\underline{K}}_{x} ( {\underline{I}}_{k} - {\underline{I}}^{- 1} {\underline{C}}_{\dot{v}} )}^{- 1} {\underline{a}}_{w} & \frac{{X}_{q}}{m} + \frac{{X}_{\dot{w}} ( {Z}_{q} + {mu}_{0} )}{m {m}_{\dot{w}}} + {{\underline{K}}_{x} ( {\underline{I}}_{k} - {\underline{I}}^{- 1} {\underline{C}}_{\dot{v}} )}^{- 1} {\underline{a}}_{q} & 0 \\ \frac{{Z}_{u}}{{m}_{\dot{w}}} - \frac{{x}_{p}}{{I}_{y}} ( {M}_{u} + \frac{{M}_{\dot{w}} {Z}_{u}}{{m}_{\dot{w}}} ) + {{\underline{K}}_{z} ( {\underline{I}}_{k} - {\underline{I}}^{- 1} {\underline{C}}_{\dot{v}} )}^{- 1} {\underline{a}}_{u} & \begin{matrix}\frac{{Z}_{w}}{{m}_{\dot{w}}} - \frac{{x}_{p}}{{I}_{y}} ( {M}_{w} + \frac{{M}_{\dot{w}} {Z}_{w}}{{m}_{\dot{w}}} ) + \\ {{\underline{K}}_{z} ( {\underline{I}}_{k} - {\underline{I}}^{- 1} {\underline{C}}_{\dot{v}} )}^{- 1} {\underline{a}}_{w}\end{matrix} & \begin{matrix}\frac{{Z}_{q} = {mu}_{0}}{{m}_{\dot{w}}} - \frac{{x}_{p}}{{I}_{y}} ( {M}_{q} + \frac{{M}_{\dot{w}} ( {Z}_{q} + {mu}_{0} )}{{m}_{\dot{w}}} ) + \\ {{\underline{K}}_{z} ( {\underline{I}}_{k} - {\underline{I}}^{- 1} {\underline{C}}_{\dot{v}} )}^{- 1} {\underline{a}}_{q}\end{matrix} & 0 \\ {{\underline{K}}_{y} ( {\underline{I}}_{k}^{- 1} - \underline{I} {\underline{C}}_{\dot{v}} )}^{- 1} {\underline{a}}_{v} & {{\underline{K}}_{y} ( {\underline{I}}_{k}^{- 1} - \underline{I} {\underline{C}}_{\dot{v}} )}^{- 1} {\underline{a}}_{w} & {{\underline{K}}_{y} ( {\underline{I}}_{k}^{- 1} - \underline{I} {\underline{C}}_{\dot{v}} )}^{- 1} {\underline{a}}_{q} & 0\end{matrix} ] , & ( 45 ) \\ {\underline{C}}_{1 lat} = [ \begin{matrix}{{\underline{K}}_{x} ( {\underline{I}}_{k}^{- 1} - \underline{I} {\underline{C}}_{\dot{v}} )}^{- 1} {\underline{a}}_{v} & {{\underline{K}}_{x} ( {\underline{I}}_{k}^{- 1} - \underline{I} {\underline{C}}_{\dot{v}} )}^{- 1} {\underline{a}}_{p} & {{\underline{K}}_{x} ( {\underline{I}}_{k}^{- 1} - \underline{I} {\underline{C}}_{\dot{v}} )}^{- 1} {\underline{a}}_{r} & 0 & 0 \\ {{\underline{K}}_{z} ( {\underline{I}}_{k}^{- 1} - \underline{I} {\underline{C}}_{\dot{v}} )}^{- 1} {\underline{a}}_{v} & {{\underline{K}}_{z} ( {\underline{I}}_{k}^{- 1} - \underline{I} {\underline{C}}_{\dot{v}} )}^{- 1} {\underline{a}}_{p} & {{\underline{K}}_{z} ( {\underline{I}}_{k}^{- 1} - \underline{I} {\underline{C}}_{\dot{v}} )}^{- 1} {\underline{a}}_{r} & 0 & 0 \\ \frac{{Y}_{v}}{{m}_{\dot{v}}} + \frac{{x}_{p}}{Δ} ( {N}_{v}^{′} + \frac{{N}_{\dot{v}}^{′} {Y}_{v}}{{m}_{\dot{v}}} ) + {{\underline{K}}_{y} ( {\underline{I}}_{k} - {\underline{I}}^{- 1} {\underline{C}}_{\dot{v}} )}^{- 1} {\underline{a}}_{v} & \begin{matrix}\frac{{Y}_{p}}{{m}_{\dot{v}}} + \frac{{x}_{p}}{Δ} ( {N}_{p}^{′} + \frac{{N}_{\dot{v}}^{′} {Y}_{p}}{{m}_{\dot{v}}} ) + \\ {{\underline{K}}_{y} ( {\underline{I}}_{k} - {\underline{I}}^{- 1} {\underline{C}}_{\dot{v}} )}^{- 1} {\underline{a}}_{p}\end{matrix} & \begin{matrix}\frac{{Y}_{r} - {mu}_{0}}{{m}_{\dot{v}}} + \frac{{x}_{p}}{Δ} ( {N}_{r}^{′} + \frac{{N}_{\dot{v}}^{′} ( {Y}_{r} - {mu}_{0} )}{{m}_{\dot{v}}} ) + \\ {{\underline{K}}_{y} ( {\underline{I}}_{k} - {\underline{I}}^{- 1} {\underline{C}}_{\dot{v}} )}^{- 1} {\underline{a}}_{r}\end{matrix} & 0 & 0\end{matrix} ] , & ( 46 ) \\ {\underline{C}}_{2} = [ \begin{matrix}\frac{{\underline{X}}_{ɛ}}{m} + \frac{{X}_{\dot{w}} {\underline{Z}}_{ɛ}}{m {m}_{\dot{w}}} + {{\underline{K}}_{x} ( {\underline{I}}_{k} - {\underline{I}}^{- 1} {\underline{C}}_{\dot{v}} )}^{- 1} ( {\underline{I}}^{- 1} {\underline{A}}_{ɛ} - \underline{ω} {\underline{ω}}^{T} ) \\ \frac{{\underline{Z}}_{ɛ}}{{m}_{\dot{w}}} - \frac{{x}_{p}}{{I}_{y}} ( {\underline{M}}_{ɛ} + \frac{{M}_{\dot{w}} {\underline{Z}}_{ɛ}}{{m}_{\dot{w}}} ) + {{\underline{K}}_{z} ( {\underline{I}}_{k} - {\underline{I}}^{- 1} {\underline{C}}_{\dot{v}} )}^{- 1} ( {\underline{I}}^{- 1} {\underline{A}}_{ɛ} - \underline{ω} {\underline{ω}}^{T} ) \\ \frac{{\underline{Y}}_{ɛ}}{{m}_{\dot{v}}} - \frac{{x}_{p}}{Δ} ( {\underline{N}}_{ɛ}^{′} + \frac{{N}_{\dot{v}}^{′} {\underline{Y}}_{ɛ}}{{m}_{\dot{v}}} ) + {{\underline{K}}_{y} ( {\underline{I}}_{k} - {\underline{I}}^{- 1} {\underline{C}}_{\dot{v}} )}^{- 1} ( {\underline{I}}^{- 1} {\underline{A}}_{ɛ} - \underline{ω} {\underline{ω}}^{T} )\end{matrix} ] , & ( 47 )\end{matrix}$$

The matrices C₃ and D are obtained by replacing the index ε with v or c respectively. H and h (x₁) are as follows:

$$\begin{matrix}\underline{H} = [ \begin{matrix}\frac{{X}_{\dot{w}} g}{{m}_{\dot{w}}} & 0 & 0 & 1 & - \frac{{X}_{\dot{w}}}{{m}_{\dot{w}}} & 0 & 0 & 0 & 0 & - {x}_{p} & - {x}_{p} \\ \frac{m g}{{m}_{\dot{w}}} ( 1 - \frac{{x}_{p} {M}_{\dot{w}}}{{I}_{y}} ) & - g & 0 & 0 & \frac{m}{{m}_{\dot{w}}} ( 1 - \frac{{x}_{p} {M}_{\dot{w}}}{{I}_{y}} ) & 0 & 0 & 0 & - \frac{{x}_{p}}{{I}_{y}} ( {I}_{z} - {I}_{z} ) & - \frac{{x}_{p} {I}_{zx}}{{I}_{y}} & \frac{{x}_{p} {I}_{cx}}{{I}_{y}} \\ 0 & 0 & ( \frac{{y}_{\dot{v}} g}{{m}_{\dot{v}}} + \frac{{x}_{p} {N}_{\dot{v}}^{′} m g}{Δ {m}_{\dot{v}}} ) & 0 & 0 & \frac{m}{{m}_{\dot{v}}} ( 1 + \frac{{x}_{p} {N}_{\dot{v}}^{′}}{Δ} ) & \frac{{x}_{p} {I}_{qr 2}}{Δ} & \frac{{x}_{p} {I}_{pq 2}}{Δ} & 0 & 0 & 0\end{matrix} ] , & ( 48 ) \\ \underline{h} ( {\underline{x}}_{1} ) = [ \begin{matrix}cos θcos φ - 1 \\ cos θcos φ \\ cos θsin φ \\ - qw + rv \\ - pv + q Δ u \\ - r Δ u + pw \\ qr \\ pq \\ rp \\ {r}^{2} \\ {p}^{2}\end{matrix} ] & ( 49 )\end{matrix}$$

The non-linear simulation model described in equation (33) contains an efficacy matrix F, which takes into account the non-linear properties of system variables. The efficacy matrix F is given in equation (42).

If the model is now expanded by aerodynamic, structurally dynamic and aeroelastic non-linearities, the following are given:
a.) additional entries in the non-linearity vector g (x₁), for example g₁₄(w)=w²+3w⁴, g₁₅(υ)=υ², g₁₆(ν₁)=ν₁², g₁₇(ν₂)=S g n (ν₂), s g n being the “signum function” of mathematics, and
b.) additional columns in the matrix

$$[ \begin{matrix}\underline{F} \\ \underline{0} \\ \underline{0}\end{matrix} ]$$

from equation (33):

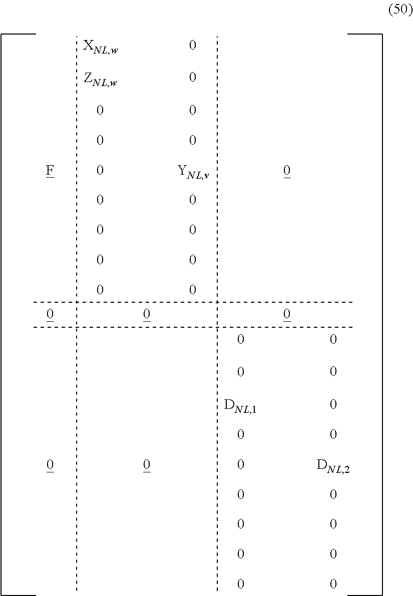

The variables X_{NL,w}, Z_{NL,w}, Y_{NL,υ}, D_{NL,1} and D_{NL,2} describe the strength of influence of the non-linearity.

The non-linear simulation model presented in equation (33) can also be described in a physically clearer manner (in a generalisation of the Newtonian and Euler motion equations) as follows:

M\ddot{x}+D\dot{x}+Kx+Fg(x,\dot{x},p,t)=p+R (51)

wherein:
x=[x_flight mechanics, x_system, x_aeroelastics],
p=[p_gust, p_pilot, p_engine, p_fault],
Fg(x,\dot{x},p,t) contains all non-linearities from flight mechanics, aerodynamics, systems, engine
R=noise
and wherein:
M: expanded mass matrix
D: expanded damping matrix
K: expanded rigidity matrix

Since the transformation of equation (33) into the form of equation (50) results in modified vectors x and g (x, \dot{x}, p, t) and a modified matrix F, these new vectors and matrices are not underlined.

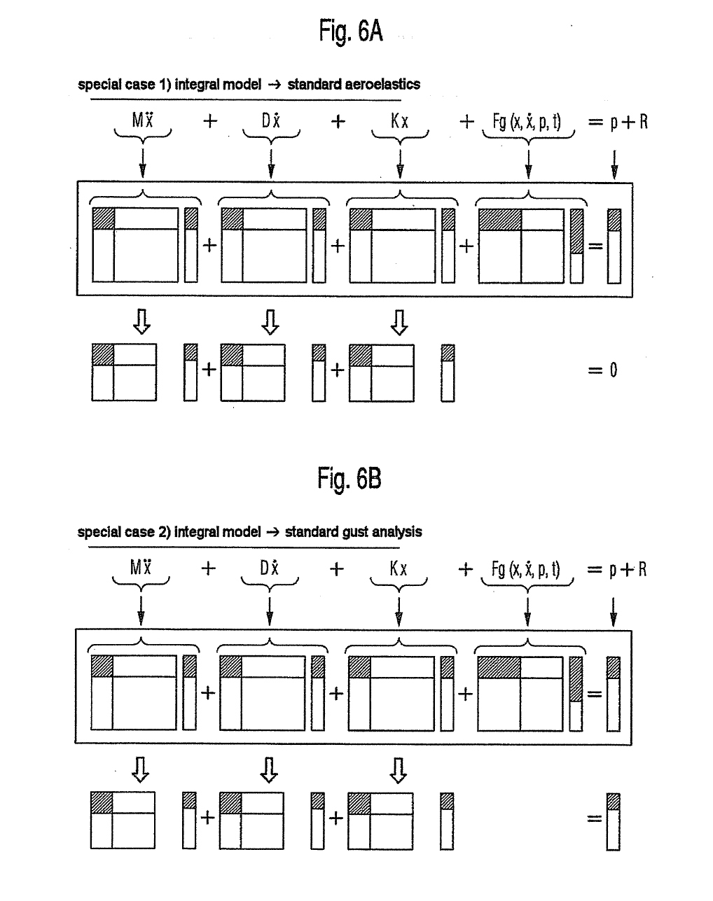

The equation system is illustrated clearly in the diagram of FIG. 5A. The equation system shown in FIG. 5A comprises a dynamic simulation model consisting of linear differential equations which is expanded by an efficacy matrix F which is multiplied by a non-linearity vector g (x, \dot{x}, p, t).

A hyper-input vector p of the aircraft is positioned in the right-hand side of the equation system with a plurality of sub-vectors. A noise vector R has additionally been introduced and describes all model uncertainties. The vector x forms a hyper-movement vector of the aircraft. As can be seen in FIG. 5A, the second time derivative \ddot{X} of the hyper-movement vector x is multiplied by an expanded mass matrix M and added to the product of the first time derivative \dot{x} of the hyper-movement vector x and an expanded damping matrix D as well as the product of a rigidity matrix K and the hyper-movement vector x as well as the product of the efficacy matrix F with the non-linearity vector g(x, \dot{x}, p,t), wherein this sum gives the hyper-input vector p of the aircraft plus noise R.

Further non-linear expansions can be presented clearly by this illustration according to FIG. 5A. Additional non-linearities in the engine dynamics, in the system behaviour or in the case of faults expand the non-linearity vector g(x, \dot{x}, p,t) and the efficacy matrix F by additional entries.

The mass matrix M, the damping matrix D and the rigidity matrix K are expanded matrices which take into account the aerodynamics and system dynamics of the aircraft in addition to the structural properties. The following applies:

K=K_{structure}+K_{aerodynamics}+K_{system}

D=D_{structure}+D_{aerodynamics}+D_{system}

M=M_{structure}+M_{aerodynamics}+M_{system}

The elements of structural and system matrices can be easily ascertained by means of physical mathematical models and methods combined with simple ground-level and laboratory tests. This does not apply to aerodynamic matrices. Aerodynamics describe generally the behaviour of bodies in compressible fluids, in particular air. In particular, aerodynamics describe forces which occur during flight of an aircraft. Apart from wind tunnel tests, which are limited in their validity and transferability, in particular in the case of unsteady aerodynamics of elastic structures, no ground-level or laboratory tests are possible. In contrast to the structural and system properties, it is thus only possible to accurately ascertain the aerodynamics by flight testing. If the matrix K_{aerodynamics} is multiplied by x, the matrix aerodynamics D_{aerodynamics} is multiplied by \dot{x} and the matrix M_{aerodynamics} is multiplied by \ddot{x}, the generalised aerodynamic distributions belonging to x, \dot{x} and \ddot{x} are given. The aerodynamic forces at each point i can thus be calculated by multiplying by the mode shape functions ƒ_{i,n}, g_{i,n} and h_{i,n} and summing up. If the multiplication is carried out for all points i which belong to an aircraft portion or component, the aerodynamic distributions for the selected aircraft portion or the selected aircraft component will be obtained.

FIG. 5B illustrates the structure of an expanded matrix. The coupling describes the strength of influence of a characteristic variable on the aircraft. The mass matrix M, the damping matrix D and the rigidity matrix K describe linear influences, whilst the efficacy matrix F indicates non-linear properties of system variables. These characteristic variables are characteristic variables of flight mechanics, on-board systems and aeroelastics. Aeroelastics describe deformations or oscillations of the aircraft or aeroplane which occur in particular on the tail or wing assembly in conjunction with an airflow owing to elastic deformation of the structure of the aircraft. Aeroelastics describe the mutual interaction between the aerodyne and aerodynamic forces. The coupling matrices thus illustrate that there is mutual interaction between the distributed or local structural movement of the aircraft and the overall movement of the aircraft. For example, an overall movement of the aircraft via the aerodynamic distributions in the left lower coupling block in the matrices M, D and K influences the dynamics of the normal modes, therefore the distributed and local movement of the aircraft and therefore the local accelerations and the loads associated therewith. The dynamics of the normal modes (therefore the distributed and local movement of the aircraft) act via the right upper coupling block on the overall movement and therefore, for example, on the acceleration of the entire aircraft. As a result, the integrated procedure when determining local accelerations, the dynamic loads associated therewith and aerodynamic data are already considerable.

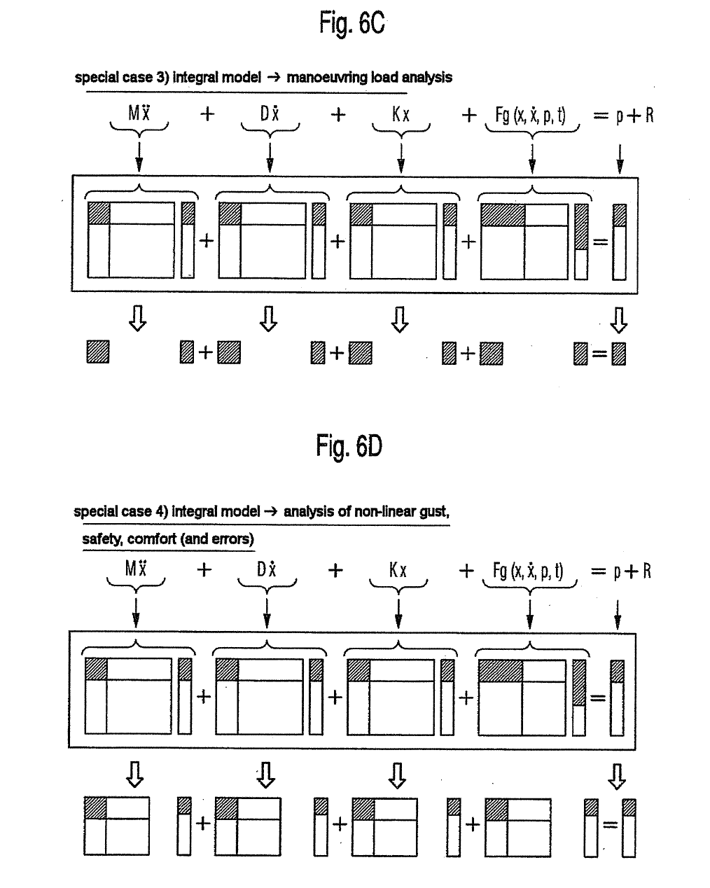

FIGS. 6A-6D shows specific cases of the generally non-linear simulation model illustrated in FIG. 5A, as is used in method according to the invention.

In the specific case shown in FIG. 6A the non-linear efficacy matrix F and the linearity vector g as well as the input vector p are zero. The specific case of a purely linear equation system of differential equations is thus encountered.

FIG. 6B describes the specific case in which the non-linear efficacy matrix F and the non-linearity vector g are zero whilst an input vector p, for example for illustrating a wind gust, is not zero. The simulation model illustrated in FIG. 6B is thus adapted, for example, for analysing standard wind gusts which act on the aircraft.

In the specific case illustrated in FIG. 6C only variables of flight mechanics are considered, and therefore the simulation model illustrated in FIG. 6C is adapted for analysis of manoeuvring loads, wherein the aircraft is manoeuvred as a whole.

The case illustrated in FIG. 6D is the integral simulation model, which is also adapted for analysis of non-linear wind gusts, safety and passenger comfort, even, during extreme flight manoeuvres and during loading in the case of faults. The non-linear simulation model present in conjunction with FIGS. 5A and 5B as well as 6A to 6D is used in the system and method 1 according to the invention to determine aerodynamic data and dynamic load distributions in an aircraft.

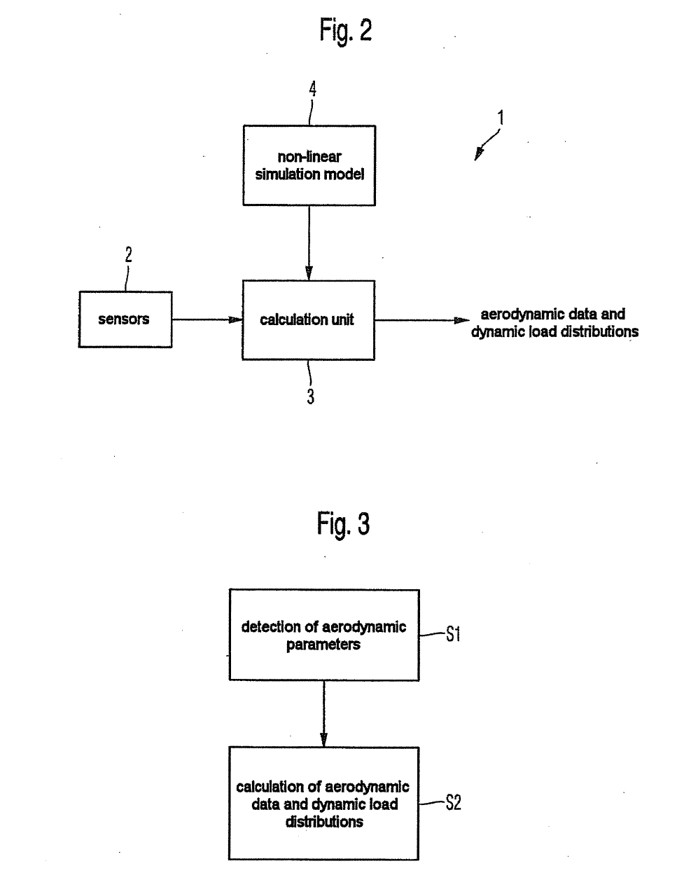

FIG. 2 shows a block diagram of a possible embodiment of the system 1 according to the invention for integrated determination of aerodynamic data and dynamic load distributions in an aircraft.

The system 1 comprises a plurality of sensors 2 which detect the aerodynamic parameters of the aircraft, either directly or indirectly. The system 1 for integrated determination of aerodynamic and dynamic load distributions comprises at least one sensor 2. These sensors 2 include sensors of different types, in particular force sensors, pressure sensors, acceleration sensors and also, for example, deformation sensors or strain gauges. The sensors detect forces and moments which act on structural elements and components of an aircraft during flight. Furthermore, the sensors 2 also detect deformations of structural elements and components during flight. The components of the aircraft may be any structural elements of the fuselage or control surfaces as well as aerofoils. The components may also be components which are only exposed to the airflow during specific phases of flight of the aircraft, for example components of the undercarriage during take-off and landing. The sensors 2 detect aerodynamic parameters and characteristic variables of the aircraft, either directly or indirectly. The different aerodynamic parameters form a parameter vector which includes different parameters for different components of the aeroplane or aircraft. For example, the parameter vector includes sensors attached to different components of the aircraft, which sensors detect the forces or moments acting on the respective component of the aircraft.

Sensors 2 may also detect an aerodynamic parameter of the aircraft, either directly or indirectly. In the case of indirect detection, an aerodynamic parameter is calculated by means of an equation system from measured variables detected via sensor. The sensors 2 are connected to a calculation unit 3. For example, the calculation unit 3 is one or more microprocessors of a computer.

In one possible embodiment, the calculation unit 3 is located within the aircraft to be examined. In an alternative embodiment, the aerodynamic parameters and measured variables detected by the sensors 2 are transferred from the aircraft, via an air interface to a ground station in which the calculation unit 3 is located.

The calculation unit 3 has access to a non-linear simulation model stored in a memory 4. The simulation model illustrated in FIG. 5A is preferably used as a non-linear simulation model. The calculation unit 3 calculates the aerodynamic data and the dynamic load distributions of the aircraft on the basis of the non-linear simulation model of the respective aircraft as a function of the aerodynamic parameters of the aircraft detected by the sensors 2.

In one possible embodiment the calculation unit 3 also calculates characteristic variables of passenger comfort and of cabin safety, and movement variables of aeroelastics and flight mechanics based on the non-linear simulation model stored in the memory 4 and as a function of the detected aerodynamic parameters.

In one possible embodiment the aerodynamic data and the dynamic load distributions as well as the characteristic variables of passenger comfort and cabin safety, and the movement variables of aeroelastics and flight mechanics are calculated by the calculation unit 3 in real time.

In one possible embodiment the data obtained are used for design optimisation of the respective aircraft. In this case fatigue loads are reduced for components of the aircraft and vibration-critical states are avoided. The aircraft can be optimised to the extent that acceleration forces acting on passengers and crew members are minimised so that crew and passenger safety is raised and flying comfort is also increased. In one possible embodiment the system according to the invention, as illustrated in FIG. 2, is used in a flight simulator to enable targeted, pilot training. The pilots are trained in such a way that the acceleration forces acting on the passengers are kept to a minimum in order to increase flying comfort in different flight situations.

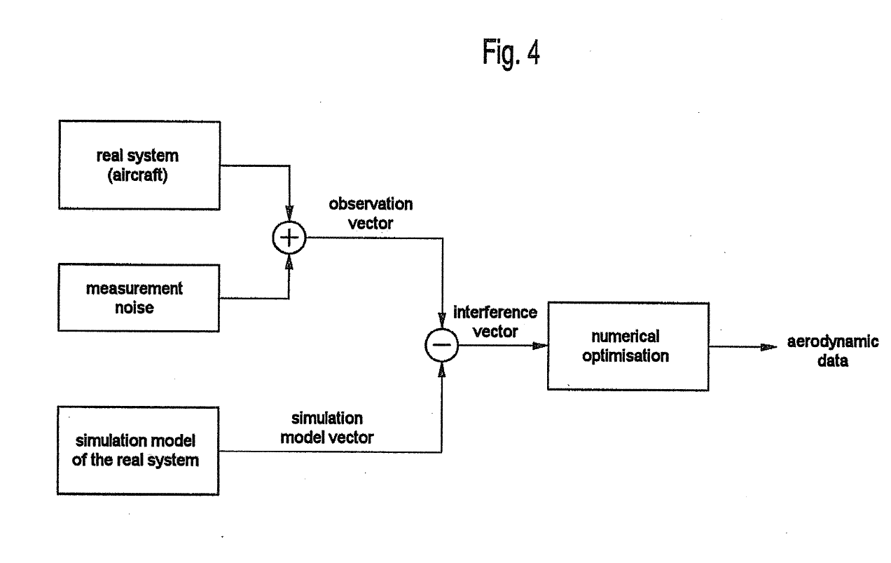

FIG. 3 shows a simple flow diagram of a possible embodiment of the method according to the invention for determining aerodynamic data and dynamic load distributions in an aircraft during flight.

In a first step S1, aerodynamic parameters of the aircraft are detected via sensor. The detection may take place directly or indirectly.

In a further step S2, the aerodynamic data and dynamic load distributions of the aircraft are then calculated on the basis of the non-linear simulation model of the aircraft provided and as a function of the aerodynamic parameters of the aircraft detected via sensor in step S1.

As illustrated in FIG. 3, in one possible embodiment the method is carried out by means of a computer program which runs on a calculation unit 3, in particular a microprocessor. This calculation unit 3 may be located within the aircraft or in a ground station. In one possible embodiment this computer program is loaded from a data carrier by the calculation unit 3.

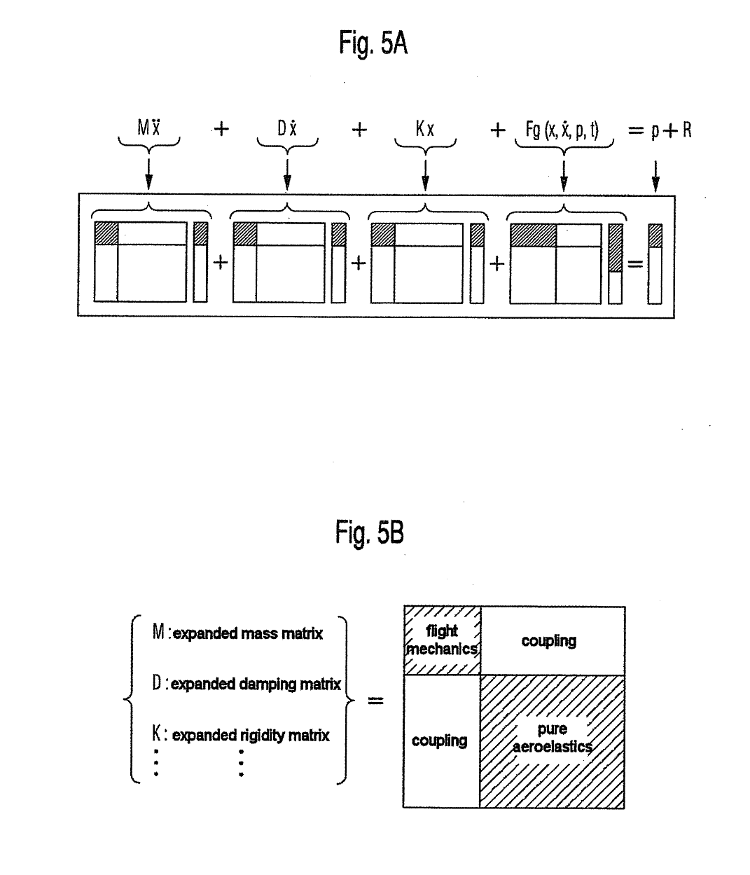

FIG. 4 shows a diagram illustrating a possible embodiment of the method according to the invention. The sensors 2 of the system 1 according to the invention provide an observation vector of the aerodynamic parameters detected via sensor for a real system or the aircraft, wherein a measurement noise has an effect.

The simulation model of the aircraft, which is stored in the memory 4, provides a simulation model vector of the aerodynamic parameters.

The calculation unit 3 or a subtraction unit contained therein calculates an interference vector for the aerodynamic parameters which is a differential vector between the observation vector of the aerodynamic parameters detected via sensor and the simulation model vector of the aerodynamic parameters.

The calculation unit 3 or a unit contained therein for numerical optimisation then minimises the calculated interference vector for the aerodynamic parameters by means of a numerical optimisation method. In one possible embodiment a maximum likelihood method is used as a numerical optimisation method.

In a further possible embodiment of the system according to the invention the stored non-linear simulation model is automatically adapted as a function of the differential vector or interference vector calculated for the aerodynamic parameters.

Starting from the non-linear simulation model illustrated in FIG. 5A, the load, comfort and safety-relevant characteristic variables and parameters can be calculated directly with the aid of discrete algebraic equations at any desired moment in time by the system 1 according to the invention.

The equation system can be solved as follows for the second derivative \ddot{x} of the state vector:

\ddot{x}=−M⁻¹(D\dot{x}+Kx−p+Fg(x,\dot{x},p,t)−R) (52)

If the mode accelerations \ddot{ε}ₙ are selected from this vector \ddot{x}, the accelerations at any points of the aeroplane or aircraft based merely on elastic deformations can be calculated with the aid of equation (22), and therefore the elastic acceleration distribution over the entire aeroplane, in particular therefore for each position of the cabin. Together with the specific load factor (see also equation (21) and the respective explanation), they form a direct measure for passenger comfort and safety.

With introduction of a state vector as a hyper-vector

$$\underline{x} = [ \begin{matrix}\dot{x} \\ x\end{matrix} ]$$

the following is given for the first derivative of this hyper-vector

$$\underline{\dot{x}} = [ \begin{matrix}\ddot{x} \\ \dot{x}\end{matrix} ] .$$

The non-linear simulation model can thus be illustrated as follows:

$$\underline{\dot{x}} = [ \begin{matrix}- {M}^{- 1} D & - {M}^{- 1} K \\ 1 & 0\end{matrix} ] \cdot \underline{x} + [ \begin{matrix}{M}^{- 1} \\ 0\end{matrix} ] \cdot p + [ \begin{matrix}- {M}^{- 1} \\ 0\end{matrix} ] \cdot Fg {( x , \dot{x} ,}_{= \underline{x}} p , t ) + [ \begin{matrix}{M}^{- 1} \\ 0\end{matrix} ] \cdot R \qquad ( 53 )$$

Based on this equation system and with the aid of discrete algebraic equations, the load, comfort and safety-relevant variables can be calculated directly at any desired moment in time. The following is given for the generalised elastic forces and loads:

p_{g}^{el}=K_{structure}x (54)

wherein in accordance with: K=K_{structure}+K_{aerodynamics}+K_{system} the matrix K_{structure} of the pure structural proportion of the expanded rigidity matrix is K. Alternatively, the generalised elastic forces and loads can be calculated as follows from the motion equations using the “force summation method”:

P_{g}^{el}=p−Fg(x,\dot{x},p,t)+R−M\ddot{x}−D\dot{x}−K_{aerodynamics}x−K_{system}x (55)

In direct analogy to equation (22), the local loads can be calculated at any point i of the aeroplane by multiplying by the mode form functions ƒ_{i,n}, g_{i,n} and h_{i,n}. In accordance with the terms M\ddot{x}=(M_{structure}+M_{aerodynamics}+M_{system dynamics})\ddot{x}, D\dot{x}=(D_{structure}+D_{aerodynamics}+D_{system dynamics}_{^{k}})\dot{x} and K_{aerodynamics}:x, it is clear that the aerodynamics and in particular the aerodynamic distributions contribute significantly to the loads.

The term which contains the noise R can be given as a state-dependent matrix multiplied by a time-dependent vector function w(t):

M⁻¹R=G{x(t)}w(t) (56)

Generally, the dynamic behaviour of the system can thus be illustrated by means of the following equations:

\dot{x}(t)=ƒ{x(t),p(t),θ}+G{x(t)}w(t)

z(t)=h{x(t),p(t),θ}+ν(t) (57)

wherein:
x(t): state vector
p(t): input vector
z(t): observation vector
w(t): state noise
ν(t): measurement noise
G: input matrix of process noise
θ: parameter vector

It can be assumed for the process noise w(t) and for the measurement noise ν(t) that they include a mean value of zero and that they correspond to a white noise which comprises an uncorrelated normal distribution, wherein the covariance matrices are unknown.

The measurable state variables of the real system or of the aircraft can be illustrated as follows:

z(t)=h{x(t),p(t),θ}+ν(t) (58)

The same state variables are described in the simulation model as follows:

\hat{z}₁(θ)=h{\tilde{x}ᵢ,p_{m,i}(t),θ} (59)

An interference or differential vector emerges from this as follows:

\hat{η}ᵢ(θ)=z_{m,i}−\hat{z}ᵢ(θ) (60)

In one embodiment of the method and system according to the invention an optimal value for the parameter vector is calculated on the basis of the interference vector, based on the observation vector z. The optimal values for the elements of the parameter vector are those which minimise the interference vector. In one possible embodiment a likelihood function is used as a criterion for the optimisation.

In one possible embodiment a Hessian matrix may be provided for the parameter adaptation. This may be replaced by expected values in order to form a “Fisher information matrix” M. The interference vector is then minimised based on a reduced pseudoinverse of the Fisher information matrix M.

The method according to the invention for determining aerodynamic data can be integrated in a simulation software.

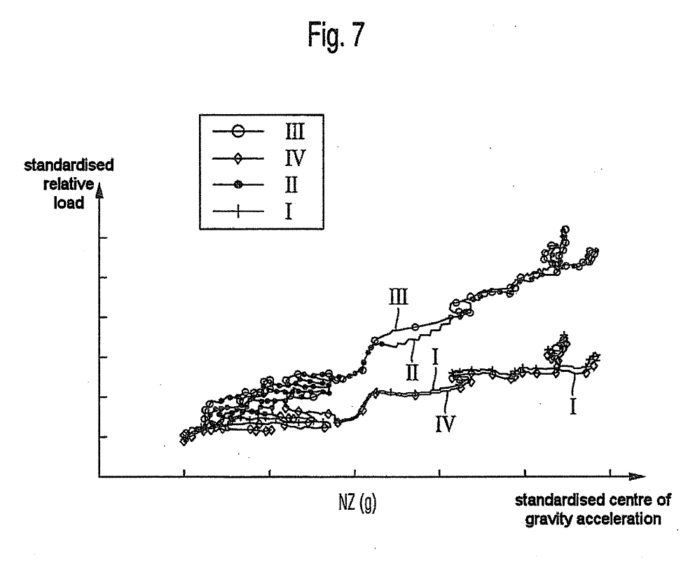

FIG. 7 shows an example of specific outputs of the calculation unit 3 on which a simulation software is run.

FIG. 7 shows, for a standardised relative load, the time curve compared to a standardised centre of gravity acceleration, wherein the load is illustrated in a winglet or an outer wing extension compared to the acceleration at the centre of gravity of the aeroplane F.

FIG. 7 shows a ‘baseline model’ I, which contains the model knowledge (for example of an engineer) before identification or flight testing. The purpose of identification and flight testing is to develop and define the model. For this purpose either parameters or additional parameterised terms are introduced into the baseline model I, and a first ‘initial model’ IV is thus obtained. These parameters form the vector θ.

The output interference shows the comparison between the ‘initial model’ IV and the ‘measured model’ III or the real system. This output interference is optimised in the first step of identification in accordance with a selected criterion. The free parameters from the ‘initial model’ IV are adapted accordingly and the results therefrom are in turn compared to the measured model III, thus providing new values for the interference vector. The final model II shows the result, in accordance with which convergence is achieved in the optimisation method.

As can be seen from FIG. 7, the temporal curve of the standardised relative load according to the ‘optimised final model’ II corresponds in a highly accurate manner to the observation vector detected via sensor.

In one possible embodiment the data is evaluated in real time. In an alternative embodiment the data obtained are recorded and evaluated at a later time.

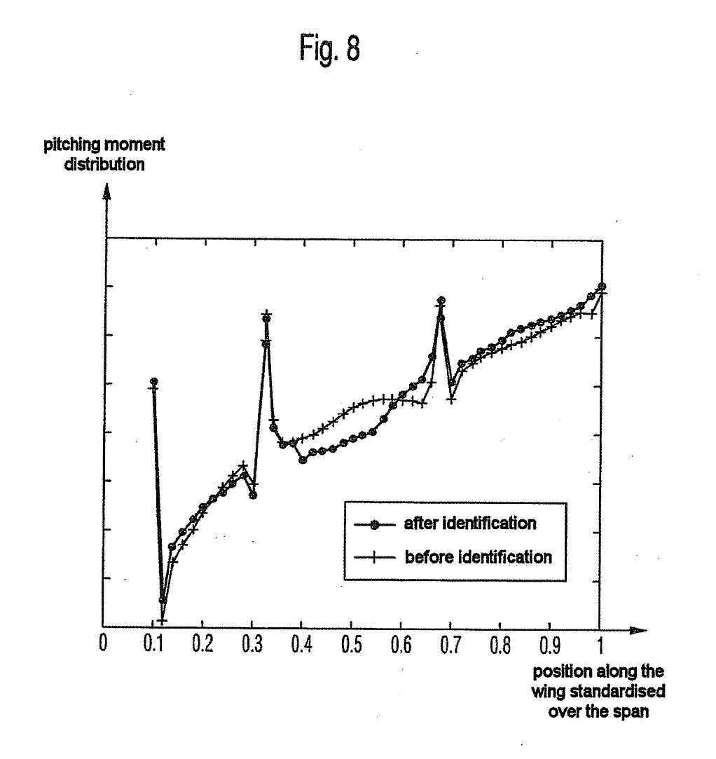

FIG. 8 shows, by way of example, how local aerodynamic distribution (in this case pitching moment distribution at the wing as a result of an angle of incidence a or a vertical speed w) was adapted during identification in order to reach the match in FIG. 7 between model II and model III.

In this case the x axis represents the position along the wing standardised over the span. The line with the plus sign results from the model before identification, that is to say the ‘initial model’ IV. The line with the dots results from the identified model, that is to say the ‘optimised final model’ II. The points on one curve and the plus signs on the other curve correspond to the discrete description by the index i.

The invention provides a method and a system 1 for integrated determination of aerodynamic data and dynamic load distributions and local accelerations in an aircraft, in particular in an aeroplane, during flight. Sensors 2 for direct and indirect detection of aerodynamic parameters, local acceleration and/or structural loads of the aircraft are provided on the aircraft. A calculation unit 3 provided in the aircraft or in the ground station calculates the aerodynamic data and dynamic load distributions of the aircraft on the basis of a non-linear simulation model of the aircraft as a function of the detected aerodynamic parameters of the aircraft. The calculation may take place in real time.

Preferred embodiments of the method and the system are described in the following:

1. A system for integrated determination of aerodynamic data, dynamic load distributions and accelerations in an aircraft during flight, said system comprising:
(a) sensors for direct or indirect detection of aerodynamic parameters of the aircraft;
(b) a calculation unit which calculates the aerodynamic data and the dynamic load distributions of the aircraft on the basis of a non-linear simulation model of the aircraft as a function of the detected aerodynamic parameters of the aircraft.
2. The system according to embodiment 1, wherein the calculation unit calculates characteristic variables of passenger comfort, cabin safety and movement variables of aeroelastics and flight mechanics on the basis of the non-linear simulation model as a function of the detected aerodynamic parameters.
3. The system according to embodiment 1, wherein the steady aerodynamic data including aerodynamic distributions are measured directly and structural loads and accelerations are ascertained as a function of this measured data.
4. The system according to embodiment 1, wherein steady and unsteady aerodynamic data including steady and unsteady aerodynamic distributions are measured and identified directly and indirectly, and structural loads and characteristic variables of passenger comfort and cabin safety are ascertained as a function of this measured data.
5. The system according to embodiment 1, wherein some of the steady aerodynamic data, structural loads and accelerations are measured directly and, as a function of this measured data, the unmeasured aerodynamic data, structural loads and accelerations are ascertained and the associated simulation models are validated and expanded.
6. The system according to embodiment 1, wherein some of the steady and unsteady aerodynamic data, structural loads and accelerations are measured directly and, as a function of this measured data, the unmeasured steady and unsteady aerodynamic data, structural loads and accelerations are ascertained and the associated simulation models are validated and expanded.
7. The system according to embodiment 1, wherein the aerodynamic data and the dynamic load distributions as well as the characteristic variables of passenger comfort, cabin safety and the movement variables of aeroelastics and flight mechanics are calculated by the calculation unit in real time.
8. The system according to embodiment 1, wherein the calculation unit calculates an interference vector for the aerodynamic parameters which is a differential vector between an observation vector of the aerodynamic parameters detected via sensor and a simulation model vector of the aerodynamic parameters.
9. The system according to embodiment 6, wherein the calculation unit minimises the interference vector for the aerodynamic parameters by means of a numerical optimisation method.
10. The system according to embodiment 7, wherein the numerical optimisation method is a maximum likelihood method.
11. The system according to embodiment 6, wherein the calculation unit automatically adapts the non-linear simulation model as a function of the calculated differential vector for the aerodynamic parameters.
12. The system according to embodiment 1, wherein the aerodynamic parameters and/or the structural loads are detected via sensor by pressures.
13. The system according to embodiment 1, wherein the aerodynamic parameters and/or the structural loads are detected via sensor by the deformations of structural components or by mechanical forces acting on structural components.
14. The system according to embodiment 1, wherein the non-linear simulation model is stored in a memory (4).
15. The system according to embodiment 1, wherein the stored non-linear simulation model comprises non-linear differential equations.
16. The system according to embodiment 2, wherein the characteristic variables of passenger comfort calculated by the calculation unit include acceleration vectors on passenger seats within a passenger cabin of the aircraft and an acceleration vector on a centre of gravity of the aircraft.
17. The system according to embodiment 1, wherein a physical observer is formed on the basis of ascertained aerodynamic data, the physical observer being used with minimal validation effort in a mass-production aircraft for structural load monitoring.
18. An aircraft comprising a system according to embodiment 1, wherein the aircraft is an aeroplane or a helicopter.
19. A method for determining aerodynamic data and dynamic load distributions in an aircraft during flight, said method comprising the following steps:
(a) direct or indirect detection via sensor of aerodynamic parameters of the aircraft;
(b) calculation of aerodynamic data and dynamic load distributions of the aircraft on the basis of a non-linear simulation model of the aircraft and as a function of the aerodynamic parameters of the aircraft detected via sensor.
20. The method according to embodiment 19, wherein steady aerodynamic data including aerodynamic distributions are measured directly, and structural loads and characteristic variables of passenger comfort and of cabin safety are ascertained as a function of this measured data.
21. The method according to embodiment 19, wherein steady and unsteady aerodynamic data including steady and unsteady aerodynamic distributions are measured and identified directly and indirectly, and structural loads and characteristic variables of passenger comfort and of cabin safety are ascertained as a function of this measured data.
22. The method according to embodiment 19, wherein some of the steady aerodynamic data, structural loads and accelerations are measured directly and, as a function of this measured data, the unmeasured aerodynamic data, structural loads and accelerations are ascertained and the respective simulation models are validated and expanded.
23. The method according to embodiment 19, wherein some of the steady and unsteady aerodynamic data, structural loads and accelerations are measured directly and, as a function of this measured data, the unmeasured steady and unsteady aerodynamic data, structural loads and accelerations are ascertained and the respective simulation models are validated and expanded.
24. A computer program with program commands for carrying out the method according to embodiment 19.
A data carrier which stores the computer program according to embodiment 24.

### LIST OF REFERENCE NUMERALS

1 system for integrated determination of aerodynamic data
2 sensors
3 calculation unit
4 memory for a non-linear simulation model

1. A method for optimising a design of an aircraft, comprising the following steps:
(a) direct or indirect detection via sensor of aerodynamic parameters of the aircraft by means of sensors, wherein the aerodynamic parameters are selected from the group consisting of: forces, accelerations, pressures, moments, deformations and expansions;
(b) calculation, by means of a calculation unit, of aerodynamic data and dynamic load distributions of the aircraft on the basis of a non-linear simulation model of the aircraft and as a function of the aerodynamic parameters of the aircraft detected via sensor, wherein the calculation unit calculates an interference vector for the aerodynamic parameters which is a differential vector between an observation vector of the aerodynamic parameters detected via sensor and a simulation model vector of the aerodynamic parameters, wherein the calculation unit minimises the interference vector for the aerodynamic parameters by means of a numerical optimisation method; and
(c) optimising a design of the aircraft as a function of the calculated aerodynamic data and dynamic load distributions.

2. The method according to claim 1, wherein the calculation unit calculates characteristic variables of passenger comfort, cabin safety and movement variables of aeroelastics and flight mechanics on the basis of the non-linear simulation model as a function of the detected aerodynamic parameters.

3. The method according to claim 1, wherein steady aerodynamic data including aerodynamic distributions are measured directly and structural loads and accelerations are ascertained as a function of this measured data.

4. The method according to claim 1, wherein steady and unsteady aerodynamic data including steady and unsteady aerodynamic distributions are measured and identified directly and indirectly, and structural loads and characteristic variables of passenger comfort and cabin safety are ascertained as a function of this measured data.

5. The method according to claim 1, wherein some of the steady aerodynamic data, structural loads and accelerations are measured directly and, as a function of this measured data, the unmeasured aerodynamic data, structural loads and accelerations are ascertained and the respective simulation models are validated and expanded.

6. The method according to claim 1, wherein some of the steady and unsteady aerodynamic data, structural loads and accelerations are measured directly and, as a function of this measured data, the unmeasured steady and unsteady aerodynamic data, structural loads and accelerations are ascertained and the respective simulation models are validated and expanded.

7. The method according to claim 2, wherein the aerodynamic data and dynamic load distributions as well as the characteristic variables of passenger comfort, cabin safety and movement variables of aeroelastics and flight mechanics are calculated by the calculation unit (3) in real time.

8. The method according to claim 1, wherein the numerical optimisation method is a maximum likelihood method.

9. The method according to claim 1, wherein the calculation unit automatically adapts the non-linear simulation model as a function of the calculated differential vector for the aerodynamic parameters.

10. The method according to claim 1, wherein the aerodynamic parameters and/or the structural loads are detected via sensor by pressures.

11. The method according to claim 1, wherein the aerodynamic parameters and/or the structural loads are detected via sensor by the deformations of structural components or by mechanical forces acting on structural components.

12. The method according to claim 1, wherein the non-linear simulation model is stored in a memory.

13. The method according to claim 1, wherein the stored non-linear simulation model comprises non-linear differential equations.

14. The method according to claim 2, wherein the characteristic variables of passenger comfort calculated by the calculation unit include acceleration vectors on passenger seats within a passenger cabin of the aircraft and an acceleration vector on a centre of gravity of the aircraft.

15. The method according to claim 1, wherein a physical observer is formed on the basis of the ascertained aerodynamic data, the physical observer being used with minimal validation effort in a mass-production aircraft for structural load monitoring.

16. A computer program with program commands for carrying out the method according to claim 1.

17. A data carrier which stores the computer program according to claim 16.
